(19) United States
(12) Patent Application Publication
(10) Pub. No.: US 2004/0084482 A1
(43) Pub. Date: May 6, 2004

(54) Fluid dispensing apparatus

(76) Inventors: William P. Sumner, Kingsport, TN (US); Don K. Shinn, Jonesborough, TN (US); Sanford L. Zahler, Johnson City, TN (US)

Correspondence Address: MOORE & VAN ALLEN, PLLC, 2200 W MAIN STREET, SUITE 800, DURHAM, NC, 27705, US

(21) Appl. No.: 10/065,620

(22) Filed: Nov. 4, 2002

(51) Int. Cl. B67D 5/42

(52) U.S. Cl. 222/387

(57) ABSTRACT

An apparatus is provided for use with a device for dispensing fluid from a container with an open end and a closed end. A follower is movably disposed in the container and fluid is held between the follower and the open end of the container. An air inlet opening is provided between the follower and the closed end of the container. The apparatus comprises a housing defining a piston chamber, a piston disposed for reciprocal movement in the chamber and an actuator movably mounted to the housing for reciprocating the piston. The housing has an air inlet duct, an air outlet duct, a fluid inlet duct and a fluid outlet duct, all of which open into the chamber. The housing sealingly mounts to the open end of the container such that the interior of the container is in fluid communication with the fluid inlet duct. The piston sealingly engages the chamber walls at two longitudinally spaced locations for dividing the chamber into a first volume and a second volume. The air inlet and air outlet ducts open into the first volume and the fluid inlet and fluid outlet ducts open into the second volume. The piston forces air through the air outlet duct and fluid through the fluid outlet duct when it moves into the chamber and draws fluid into the chamber through the fluid inlet duct and air into the chamber through the air inlet duct when it moves out of the chamber.

### BACKGROUND OF INVENTION

This invention relates generally to a hand-held device for dispensing a fluid, and more particularly to a device that includes an integral air delivery system for dispensing the fluid.

Hand-held devices are used extensively for dispensing fluids, such as those for use in automobile maintenance. Automotive fluids range from those which are light and easy to move, such as air and water, to heavy, high viscosity fluids such as oil, grease and the like. The latter demand high pumping pressure to achieve even moderately adequate flow rates.

Hand-held devices for delivering high viscosity fluids such as grease, or grease guns, are well known. Grease guns generally include a head and a lubricant-containing metal cylinder removably attached to the head. Lubricant is contained in the cylinder either in bulk or in lubricant cartridges loaded into the cylinder. A manually actuated dispensing mechanism associated with the gun head is used for dispensing the lubricant contained in the cylinder. The dispensing mechanism operates to pressurize the cylinder and force lubricant toward an outlet hose attached to the head of the gun. For this purpose, a plunger is disposed in the cylinder to compress the lubricant. Compressive force is supplied by a compression spring housed between the plunger and the closed distal end of the cylinder. Alternatively, the pressure is applied via the use of compressed air, supplied from an external source, that is transported into the rear of the cylinder behind the plunger.

A significant drawback of conventional grease guns is the difficulty of reloading lubricant into the spent cylinder. In a cartridge-loaded grease gun, for example, the user must detach the metal cylinder from the head of the gun, remove the spent lubricant cartridge from the cylinder, pull back the plunger against the force of the spring using an external handle provided for that purpose, lock the plunger in place at the rear of the cylinder, remove the cover on the replacement lubricant cartridge, place the replacement lubricant cartridge in the cylinder, reattach the cylinder to the gun head and release the plunger for applying pressure to the lubricant in the cartridge. Reloading a grease gun is thus a relatively cumbersome process. In addition, because of the multiple instances in which the user is exposed to lubricant in the process, reloading is invariably a messy endeavor.

Another drawback of the conventional grease gun is that it is often difficult for the user to determine the type and amount of lubrication loaded in the gun. The user often must dispense a sample amount of lubricant from the gun to determine the specific type of lubricant contained therein. Further, it is difficult, without removing the lubricant cylinder from the grease gun head, to determine the amount of lubricant remaining in the cylinder.

A further drawback of the typical grease gun is the cost associated with its manufacture. Many of the grease guns currently available require numerous parts for their manufacture and operation, the majority of the parts being composed of metal. The use of metal for these parts, including the lubricant cylinder, significantly adds to the cost of manufacturing the gun.

For the foregoing reasons, there is a need for a hand-held fluid dispensing apparatus that is easy to load and that can be loaded without excess mess. Ideally, the new hand-held fluid dispensing apparatus is inexpensive to manufacture and easy to use for various lubricating and other fluid dispensing jobs.

### SUMMARY OF INVENTION

According to the present invention, an apparatus is provided for use with a device for dispensing fluid from a container for holding fluid. The container has an open first end and a closed second end. A follower is movably disposed in the container and the follower sealingly engages the inner surface of the container so that the fluid is held between the follower and the open first end of the container. The container has an air inlet opening between the follower and the closed second end of the container. The apparatus for dispensing fluid from the container comprises a housing defining a piston chamber closed at at least one end, a piston disposed in the piston chamber and an actuator mounted to the housing. The housing has an air inlet duct, an air outlet duct adapted to be connected to the air inlet opening in the container, a fluid inlet duct and a fluid outlet duct, all of the ducts opening into the piston chamber. The housing is adapted to be sealingly mounted to the open first end of the container such that the interior of the container is in fluid communication with the fluid inlet duct. The piston is disposed for reciprocal movement in the piston chamber. The periphery of the piston disposed in the piston chamber sealingly engages the chamber walls at two longitudinally spaced locations for dividing the piston chamber into a first fluid-tight volume between the two sealingly engaged positions and a second fluid tight volume between the second sealingly engaged position and the closed end of the piston chamber. The air inlet and air outlet ducts open into the first volume and the fluid inlet and fluid outlet ducts open into the second volume. When the piston moves into the piston chamber, the piston forces air in the piston chamber through the air outlet duct and fluid in the piston chamber through the fluid outlet duct. When the piston moves out of the piston chamber, the piston draws fluid into the piston chamber through the fluid inlet duct and air into the piston chamber through the air inlet duct. The actuator is movably mounted to the housing and operatively connected to the piston and reciprocates the piston when moved relative to the housing.

Also according to the present invention, an apparatus for dispensing fluid is provided including a housing defining a piston chamber closed at at least one end, a piston disposed in the piston chamber, an actuator mounted to the housing, a container for holding fluid, a follower disposed in the container and an air delivery tube. The housing has an air inlet duct, an air outlet duct, a fluid inlet duct and a fluid outlet duct, all of the ducts opening into the piston chamber. The piston is disposed for reciprocal movement in the piston chamber. The periphery of the piston sealingly engages the chamber walls at two longitudinally spaced locations for dividing the piston chamber into a first fluid-tight volume between the two sealingly engaged positions and a second fluid tight volume between the second sealingly engaged position and the closed end of the piston chamber. The air inlet and air outlet ducts open into the first volume and the fluid inlet and fluid outlet ducts open into the second volume. When the piston moves into the piston chamber, the piston forces air in the first volume of the piston chamber through the air outlet duct and fluid in the second volume of the piston chamber through the fluid outlet duct. When the piston moves out of the piston chamber, the piston draws air into the first volume of the piston chamber through the air inlet duct and fluid into the second volume of the piston chamber through the fluid inlet duct. The actuator is movably mounted to the housing and operatively connected to the piston through an opening in the housing and reciprocates the piston when moved relative to the housing. The container has an open first end and a closed second end. The open first end of the container is sealingly mounted to the housing such that the interior of the container is in fluid communication with the fluid inlet duct of the housing. A follower is movably disposed in the container and the periphery of the follower sealingly engages the inner surface of the container so that the fluid is held between the follower and the open first end of the container. An air delivery tube is connected at one end with the air outlet duct and opens at the other end into the container between the closed second end of the container and the follower. The air delivery tube delivers air between the closed second end of the container and the follower upon movement of the piston into the piston chamber. The reciprocation of the piston in the piston chamber increases the air pressure in the closed second end of the container. This increase in air pressure forces the follower to move axially relative to the container toward the open first end of the container, pushing fluid through the fluid inlet duct into the second volume of the piston chamber.

Further, according to the present invention, a fluid dispensing apparatus is provided comprising a housing defining a piston chamber closed at at least one end, a piston disposed in the piston chamber, an actuator mounted to the housing, a container, a fluid disposed in the container, a follower disposed in the container and an air delivery tube. The housing has an air inlet duct, an air outlet duct, a fluid inlet duct and a fluid outlet duct, all of the ducts opening into the piston chamber. The piston is disposed for reciprocal movement in the piston chamber. The periphery of the piston sealingly engages the chamber walls at two longitudinally spaced locations for dividing the piston chamber into a first fluid-tight volume between the two sealingly engaged positions and a second fluid tight volume between the second sealingly engaged position and the closed end of the piston chamber. The air inlet and air outlet ducts open into the first volume and the fluid inlet and fluid outlet ducts open into the second volume. When the piston moves into the piston chamber, the piston forces air in the first volume of the piston chamber through the air outlet duct and the fluid in the second volume of the piston chamber through the fluid outlet duct. When the piston moves out of the piston chamber, the piston draws air into the first volume of the piston chamber through the air inlet duct and fluid into the second volume of the piston chamber through the fluid inlet duct. The actuator is movably mounted to the housing and operatively connected to the piston through an opening in the housing and reciprocates the piston when moved relative to the housing. The container has an open first end and a closed second end. The open first end of the container is sealingly mounted to the housing such that the interior of the container is in fluid communication with the fluid inlet duct. The follower is movably disposed in the container and the periphery of the follower sealingly engages the inner surface of the container so that the fluid is held between the follower and the open first end of the container. The air delivery tube is connected at one end with the air outlet duct and opens at the other end into the container between the closed second end of the container and the follower. The air delivery tube delivers air between the closed second end of the container and the follower upon movement of the piston into the piston chamber. The reciprocation of the piston in the piston chamber increases the air pressure in the closed second end of the container. This increase in air pressure forces the follower to move axially relative to the container toward the open first end of the container, pushing fluid through the fluid inlet duct into the second volume of the piston chamber.

### BRIEF DESCRIPTION OF DRAWINGS

For a more complete understanding of the present invention, reference should now be had to the embodiments shown in the accompanying drawings and described below. In the drawings:

FIG. 1 is a side elevation view of a fluid dispensing apparatus according to the present invention;

FIG. 2 is a longitudinal cross-section of the fluid dispensing apparatus shown in FIG. 1;

FIG. 3 is side elevation view of a piston for use in a fluid dispensing apparatus according to the present invention;

FIG. 4 is an exploded perspective view of a container, an air delivery tube and a follower for use in a fluid dispensing apparatus according to the present invention;

FIG. 5 is a longitudinal cross-section of the fluid dispensing apparatus shown in FIG. 2 with the lever at the end of a fluid delivery stroke; and

FIG. 6 is a longitudinal cross-section of the fluid dispensing apparatus shown in FIG. 2 with the lever returning to the position shown in FIG. 2.

### DETAILED DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

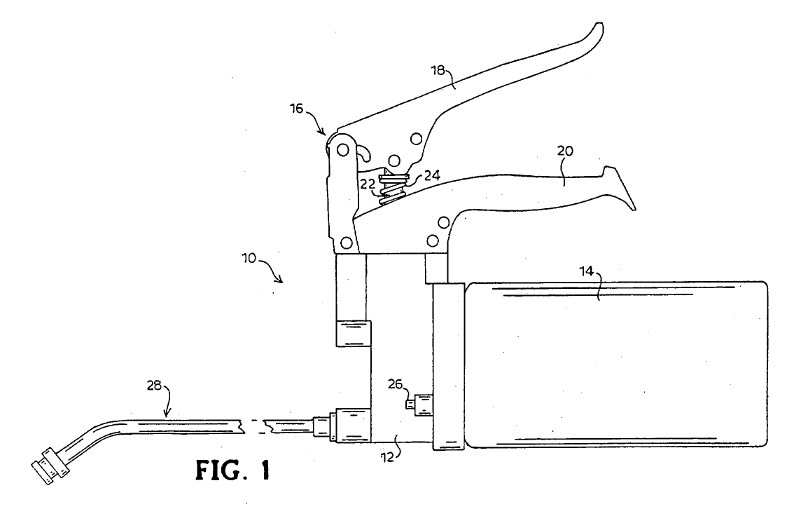

Referring now to the drawings, wherein like reference numerals designate corresponding or similar elements throughout the several views, an embodiment of a fluid dispensing apparatus according to the present invention is shown in FIG. 1 and generally designated at 10. The apparatus 10 comprises a head 12, a container 14, a pistol-grip 16 including a pivoting lever 18 and a handle 20 rigidly attached to the head 12, and a reciprocating piston 22 connected at one end to the lever 18 and extending into the head 12. A spring 24 surrounding the piston 22 is positioned between the head 12 and the lever 18 for biasing the lever 18 and piston 22 away from the head 12. A push-button air pressure release valve 26 of the type typically used in the art extends through the head 12 for the purpose of relieving air pressure within the device 10.

When a user desires to dispense fluid, the user holds the pistol grip 16 with the palm of the hand on the lever 18 and fingers around the handle 20. Applying pressure moves the lever 18 toward the handle 20 and drives the piston 22 into the head 12 for pumping fluid from an outlet conduit 28, as will be described below. The structure and operation of the pistol-grip 16 is described in U.S. Pat. No. 5,277,339, the contents of which are hereby incorporated by reference. Accordingly, a detailed explanation of the pistol-grip 16 is deemed unnecessary for understanding of the present invention by one of ordinary skill in the art. However, it is understood that any pistol-grip or lever-type actuating mechanism may be used to reciprocate the piston 22 for dispensing lubricant in accordance with the present invention. Moreover, although a rigid pipe is depicted as the outlet conduit 28 in the FIGS., a flexible outlet hose or any other suitable conduit may be used.

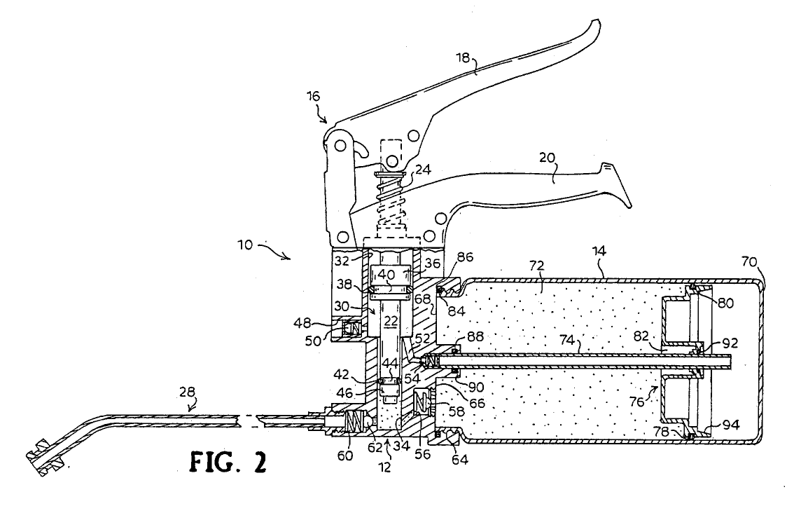

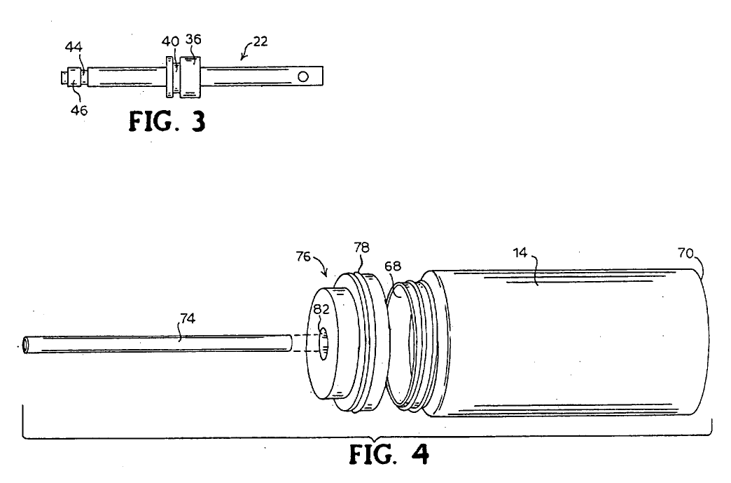

As shown in FIG. 2, a piston chamber 30 is formed inside the head 12. The piston chamber 30 is open at one end of the head 12 for receiving the piston 22. A first portion 32 of the piston chamber 30 proximal the open end is wider in diameter than a second distal portion 34 of the piston chamber 30. The piston 22 (FIG. 3) has a wider intermediate portion 36 which fits within the first portion 32 of the piston chamber 30. As seen in FIG. 2, the piston 22 extends partially into the second portion 34 of the piston chamber 30 when the fluid dispensing apparatus 10 is not in use. An O-ring 38 is attached in a peripheral groove 40 on the wider intermediate portion 36 of the piston 22 to sealingly engage the walls of the first portion 32 of the piston chamber 30. Similarly, an O-ring 42 is attached in a peripheral groove 44 adjacent the distal end 46 of the piston 22 to sealingly engage the walls of the second portion 34 of the piston chamber 30. The O-rings 38, 42 attached to the piston 22 provide fluid-tight separation of the piston chamber 30 while allowing the piston 22 to reciprocate linearly relative to the walls of the piston chamber 30 due to material deformation of the O-rings 38, 42.

The head 12, pistol grip 16 and piston 22 are preferably made of metal or of a synthetic polymeric material. Suitable synthetic polymeric materials are those that are rigid, including but not limited to, polycarbonate, polyethylene terephthalate (PET), high density polyethylene (HDPE) and the like. Nevertheless, any material of sufficient strength to withstand the forces the fluid dispensing apparatus 10 may encounter in use may be used. Moreover, the use of the O-rings 38, 42 attached to the piston 22 eliminate the need for a precision cut piston chamber 30 and, thus, allows for the head 12 to be inexpensively manufactured. It is understood that the scope of the invention is not intended to be limited by the materials listed herein, but may be carried out using any materials that allow the construction and operation of the described fluid dispensing apparatus 10.

An air inlet duct 48 extends through the front wall of the head 12 and opens into the first portion 32 of the piston chamber 30. An elastomeric ball check valve 50 positioned in the air inlet duct 48 permits air to flow only from the ambient into the piston chamber 30. An air outlet duct 52 extends from the first portion 32 of the piston chamber 30 and through the rear wall of the head 12. An elastomeric ball check valve 54 positioned in the air outlet duct 52 permits air to flow only out of the first portion 32 of the piston chamber 30. A fluid inlet duct 56 extends through the rear wall of the head 12 and opens into the second portion 34 of the piston chamber 30. A metal ball check valve 58 positioned in the fluid inlet duct 56 permits fluid to flow only into the second portion 34 of the piston chamber 30. A fluid outlet duct 60 extends from the second portion 34 of the piston chamber 30 and through the front wall of the head 12. A metal ball check valve 62 positioned in the fluid outlet duct 60 permits fluid to flow only out of the second portion 34 of the piston chamber 30. The fluid outlet duct 62 is adapted to threadably receive the outlet conduit 28.

Although ball check valves are shown, it is understood that other suitable check valves, such as flap check valves and the like, may be used. The check valves can be manufactured from metal, plastic, elastomeric material, or any other suitable material. Preferably, the valves 50, 54 positioned in the air inlet and outlet ducts 48, 52 are formed from an elastomeric material. Because petroleum based fluids may not interact well with elastomeric material, the valves 58, 62 positioned in the lubricant inlet and outlet ducts 56, 60 are preferably composed of metal. Alternatively, the air and fluid outlet ducts 52, 60 can be longitudinally spaced toward the closed end of the piston chamber 30 relative to the air and fluid inlet ducts 48, 56, respectively. Thus, as the piston 22 moves into the piston chamber 30, the periphery of the piston 22 will seal the air and fluid inlet ducts 48, 56. In this arrangement, check valves need not be provided in the air and fluid inlet ducts 48, 56.

The rear of the head 12 comprises a circular threaded flange 64 defining a recess 66. The threaded flange 64 is preferably composed of the same material used for the head 12. However, it is contemplated that the threaded flange 64 could be composed of a material different from that of the head 12 as long as the chosen material permits the container 14 to sealingly engage the circular threaded flange 64 of the head 12, as will be described below.

Referring to FIG. 4, the container 14 has an open first end 68 and a closed second end 70 and is adapted for containing fluid 72 to be dispensed. An elongated hollow air delivery tube 74 and a cup-shaped follower 76 are disposed inside the container 14. An O-ring 78 is seated in a peripheral groove 80 on the outside of the follower 76 to ensure that the follower 76 sealingly engages the inner wall of the container 14. At the center of the follower 76 is an opening 82 designed to permit the air delivery tube 74 to slidingly pass through the follower 76. The container 14, hollow air delivery tube 74, and follower 76 are preferably made of a metal or synthetic polymeric material. Suitable synthetic polymeric materials are those that are rigid, including but not limited to, polycarbonate, polyethylene terephthalate (PET), high density polyethylene (HDPE) and the like. Nevertheless, any material of sufficient strength to withstand the forces the fluid dispensing apparatus 10 may encounter in use may be used.

The open first end 68 of the container 14 is externally threaded for coupling with the circular threaded flange 64 on the head 12. As best seen in FIG. 2, an O-ring 84 is seated in a groove 86 in the flange 64 for sealing the connection between the head 12 and the container 14. The air delivery tube 74 connects at one end to the air outlet duct 52 in the head 12 and extends longitudinally from the open first end 68 of the container 14 to the closed second end 70 of the container 14. An O-ring 88 is seated in a groove 90 inside the air outlet duct 52 to sealingly engage the air delivery tube 74. An O-ring 92 is contained within the opening 78 of the follower 76 to ensure that the area between the follower 76 and the air delivery tube 74 is sealed. The thickness of the peripheral wall 94 of the follower 76 tapers rearwardly to promote low friction movement of the follower 76 relative to the container 14 and to allow some deflection, as necessary, to counteract any irregularities in the shape of the container 14. Thus, the volume defined by the closed end 70 of the container 14 and the follower 76 is sealingly separated from the volume on the other side of the follower 76 at the open end 68 of the container 14. The fluid 72 to be dispensed is placed in the container 14 between the follower 76 and the open first end 68 of the container 14. It is anticipated that a wide variety of fluids may be dispensed using the apparatus 10 of the present invention, including, but not limited to, for example, lubricants such as grease and other high viscosity fluids or semi-solid materials that require high pumping pressure to achieve adequate flow rates such as caulk, glue, cake frosting and the like.

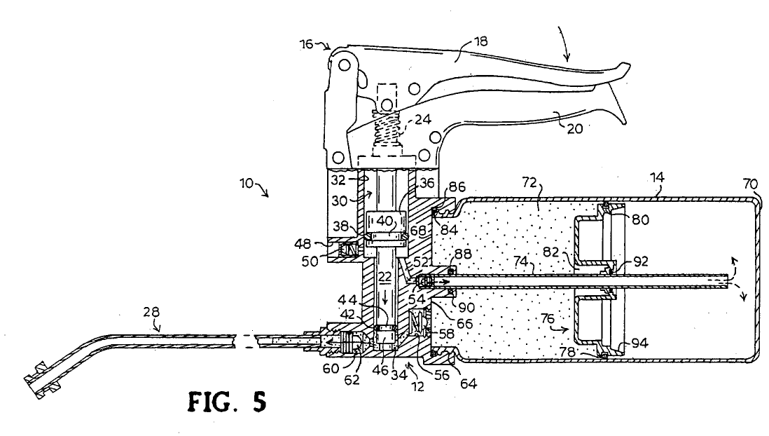

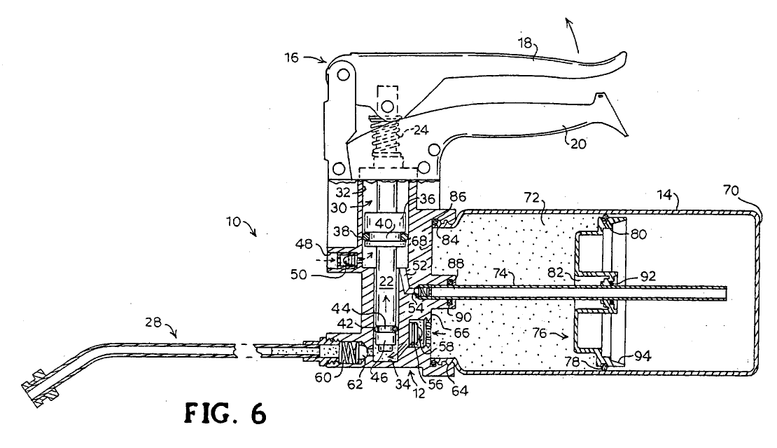

In use, the lever 18 attached to the head 12 is manually actuated toward the handle 20, moving the piston 22 into the piston chamber 30 in the head 12 as illustrated in FIG. 5. The movement of the wider intermediate portion 36 of the piston 22 in this direction forces air from the first portion 32 of the piston chamber 30 through the air outlet duct 52 and air delivery tube 74 to the space between the follower 76 and the closed end 70 of the container 14. The increase in air pressure forces the follower 76 to the left (as seen in FIG. 5) in the container 14 and thereby forces the fluid 72 towards the open first end 68 of the container 14. Similarly, the movement of the distal end 46 of the piston 22 farther into the second portion 34 of the piston chamber 30 forces fluid in the second portion 34 of the piston chamber 30 through the fluid outlet duct 60 where it is emitted from the outlet conduit 28.

As illustrated in FIG. 6, when pressure on the lever 18 is released, the spring 24 surrounding the piston 22 forces the lever 18 away from the handle 20, moving the piston 22 out of the piston chamber 30 to its original position (as seen in FIG. 2). A vacuum is created in the piston chamber 20 by the movement of the piston 22, drawing fluid through the fluid inlet duct 56 into the second portion 34 of the piston chamber 30 and air from the ambient through the air inlet duct 48 into the first portion 32 of the piston chamber 30. As described above, the O-ring 38 on the wider intermediate portion 36 of the piston 22 prevents air entering the first portion 32 of the piston chamber 30 from passing out of the open end of the piston chamber 30 and the O-ring seal 42 on the distal end 46 of the piston 22 prevents air from entering into the second portion 34 of the piston chamber 30.

When the fluid 72 in the container 14 has been fully dispensed, or when the user desires to dispense a different fluid, the user must reload the apparatus 10. To reload, the user removes the container 14 from the threaded flange 64 on the head 12 and detaches the air delivery tube 74 in the container 14 from the air outlet duct 52. The user then attaches a different container 14 and its components to the head 12 by inserting the air delivery tube 74 into the air outlet duct 52 and fastening the new container 14 to the head 12.

In an alternative embodiment of the apparatus 10, the air delivery tube 74 is permanently attached to the air outlet duct 52. In this embodiment, when the user removes the container 14 from the head 12, the air delivery tube 74 slides out of the follower 76. When the user then attaches a different container 14 to the head 12, the user must insert the air delivery tube 74 through the opening 82 in the follower before fastening the container 14 to the head 12.

It is contemplated that when an inexpensive material is used for the container 14 and its components, the user, upon dispensing all of the fluid 72 contained therein, may dispose of the entire container 14 and its contents when spent. This serves to make the process of reloading the apparatus 10 significantly easier and cleaner. Moreover, the use of an easily removable container 14 also allows for different sizes of containers 14 to be utilized with the device 10. Thus, so long as the air pressure generated by the piston is sufficient to pressurize a predetermined volume of fluid in the container 14, the user can utilize different sized containers 14 adapted to attach to the head 12 containing different volumes of fluid 72 depending on the extent of the job required. Further, at least a portion of the container 14 may be translucent so that the user can see through the container 14 to determine the type and amount of fluid 72 contained therein.

In an embodiment of the fluid dispensing apparatus where the head 12, pistol grip 16, and reciprocating piston 22, are also made of an inexpensive material, the entire apparatus 10 can be manufactured for low cost. The use of an inexpensive material for the all of the components would, thus, allow for the user, upon dispensing all of the fluid 72 contained therein, to dispose of the entire apparatus 10 without having to ever be exposed to the fluid 72 in the container.

Although the present invention has been shown and described in considerable detail with respect to only a few exemplary embodiments thereof, it should be understood by those skilled in the art that we do not intend to limit the invention to the embodiments since various modifications, omissions and additions may be made to the disclosed embodiments without materially departing from the novel teachings and advantages of the invention, particularly in light of the foregoing teachings. For example, the air delivery tube for transporting air from the head to the space between the follower and the closed second end of the container could be external from the container. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a crew may be equivalent structures.

1. An apparatus for use with a device for dispensing fluid from a container for holding the fluid, the container having an open first end and a closed second end and a follower movably disposed in the container and sealingly engaging the inner surface of the container so that the fluid is held between the follower and the open first end of the container, the container having an air inlet opening between the follower and the closed second end of the container, the apparatus comprising:
a housing defining a piston chamber closed at at least one end, the housing having an air inlet duct, an air outlet duct adapted to be connected to the air inlet opening in the container, a fluid inlet duct and a fluid outlet duct, all of the ducts opening into the piston chamber, the housing adapted to be sealingly mounted to the open first end of the container such that the interior of the container is in fluid communication with the fluid inlet duct;
a piston disposed for reciprocal movement in the piston chamber, the periphery of the piston sealingly engaging the chamber walls at two longitudinally spaced locations for dividing the piston chamber into a first fluid-tight volume between the two sealingly engaged positions and a second fluid tight volume between the second sealingly engaged position and the closed end of the piston chamber, the air inlet and air outlet ducts opening into the first volume and the fluid inlet and fluid outlet ducts opening into the second volume, the piston forcing air in the piston chamber through the air outlet duct and fluid in the piston chamber through the fluid outlet duct when moving into the piston chamber and drawing fluid into the piston chamber through the fluid inlet duct and air into the piston chamber through the air inlet duct when moving out of the piston chamber; and
an actuator movably mounted to the housing and operatively connected to the piston for reciprocating the piston upon movement of the actuator relative to the housing.

2. An apparatus for use with a fluid dispensing device as recited in claim 1, wherein the air inlet duct allows air to flow from the ambient into the piston chamber.

3. An apparatus for use with a fluid dispensing device as recited in claim 1, further comprising a valve disposed in each of the ducts, the valves allowing only one-way flow of air and fluid into the piston chamber through the air inlet duct and fluid inlet duct, respectively, and one-way flow of air and fluid out of the piston chamber through the air outlet duct and the fluid outlet duct, respectively.

4. An apparatus for use with a fluid dispensing device as recited in claim 3, wherein the valves are check valves.

5. An apparatus for use with a fluid dispensing device as recited in claim 4, wherein the valves are ball check valves.

6. An apparatus for use with a fluid dispensing device as recited in claim 1, wherein a longitudinal portion of the piston chamber extending from the closed end is smaller in cross-sectional area than the remainder of the chamber.

7. An apparatus for use with a fluid dispensing device as recited in claim 6, wherein the fluid inlet duct and the fluid outlet duct open into the smaller closed end of the piston chamber and the air inlet duct and the air outlet duct open into the larger end of the chamber.

8. An apparatus for use with a fluid dispensing device as recited in claim 7, wherein the distal end of the piston is smaller in diameter than the proximal end of the piston and slidingly fits in the smaller closed end of the piston chamber.

9. An apparatus for use with a fluid dispensing device as recited in claim 8, wherein the air outlet duct and the fluid outlet duct are longitudinally spaced toward the closed end of the piston chamber relative to the air inlet duct and fluid inlet duct, respectively, so that as the piston moves into the chamber, the periphery of the piston closes the air and fluid inlet ducts.

10. An apparatus for use with a fluid dispensing device as recited in claim 1, wherein the actuator comprises a grip and a handle movable relative to the grip, the handle operatively connected to the piston.

11. An apparatus for dispensing fluid, comprising:
a housing defining a piston chamber closed at at least one end, the housing having an air inlet duct, an air outlet duct, a fluid inlet duct and a fluid outlet duct, all of the ducts opening into the piston chamber;
a container for holding fluid, the container having an open first end and a closed second end, the open first end of the container sealingly mounted to the housing such that the interior of the container is in fluid communication with the fluid inlet duct;
a piston disposed for reciprocal movement in the piston chamber, the periphery of the piston sealingly engaging the chamber walls at two longitudinally spaced locations for dividing the piston chamber into a first fluid-tight volume between the two sealingly engaged positions and a second fluid tight volume between the second sealingly engaged position and the closed end of the piston chamber, the air inlet and air outlet ducts opening into the first volume and the fluid inlet and fluid outlet ducts opening into the second volume, the piston forcing air in the first volume of the piston chamber through the air outlet duct and fluid in the second volume of the piston chamber through the fluid outlet duct when moving into the piston chamber and drawing air into the first volume of the piston chamber through the air inlet duct and fluid into the second volume of the piston chamber through the fluid inlet duct when moving out of the piston chamber;
an actuator movably mounted to the housing and operatively connected to the piston through an opening in the housing for reciprocating the piston upon movement of the actuator relative to the housing;
a follower movably disposed in the container, the periphery of the follower sealingly engaging the inner surface of the container so that the fluid is held between the follower and the open first end of the container; and
an air delivery tube connected at one end with the air outlet duct and opening at the other end into the container between the closed second end of the container and the follower for delivering air between the closed second end of the container and the follower upon movement of the piston into the piston chamber,
wherein reciprocating the piston in the piston chamber increases the air pressure in the closed second end of the container which forces the follower to move axially relative to the container toward the open first end of the container for pushing fluid toward the fluid inlet duct leading into the second volume of the piston chamber.

12. A fluid dispensing apparatus as recited in claim 11, wherein the air inlet duct allows air to flow from the ambient into the piston chamber.

13. A fluid dispensing apparatus as recited in claim 11, further comprising a valve disposed in each of the ducts, the valves allowing only one-way flow of air and fluid into the piston chamber through the air inlet duct and fluid inlet duct, respectively, and one-way flow of air and fluid out of the piston chamber through the air outlet duct and the fluid outlet duct, respectively.

14. A fluid dispensing apparatus as recited in claim 11, wherein a longitudinal portion of the piston chamber extending from the closed end is smaller in cross-sectional area than the remainder of the chamber.

15. A fluid dispensing apparatus as recited in claim 14, wherein the fluid inlet duct and the fluid outlet duct open into the smaller closed end of the piston chamber and the air inlet duct and the air outlet duct-open into the larger end of the chamber.

16. A fluid dispensing apparatus as recited in claim 15, wherein the distal end of the piston is smaller in diameter than the proximal end of the piston and slidingly fits in the smaller closed end of the piston chamber.

17. A fluid dispensing apparatus as recited in claim 16, wherein the air outlet duct and the fluid outlet duct are longitudinally spaced toward the closed end of the piston chamber relative to the air inlet duct and fluid inlet duct, respectively, so that as the piston moves into the chamber, the periphery of the piston closes the air and fluid inlet ducts.

18. A fluid dispensing apparatus as recited in claim 11, wherein the air delivery tube slidably extends through an opening in the follower.

19. A fluid dispensing apparatus as recited in claim 11, wherein the air delivery tube is external to the container.

20. A fluid dispensing apparatus as recited in claim 11, wherein at least a portion of the container is composed of a translucent material.

21. A fluid dispensing apparatus, comprising:
a housing defining a piston chamber closed at at least one end, the housing having an air inlet duct, an air outlet duct, a fluid inlet duct and a fluid outlet duct, all of the ducts opening into the piston chamber;
a container having an open first end and a closed second end, the open first end of the container sealingly mounted to the housing such that the interior of the container is in fluid communication with the fluid inlet duct;
a fluid disposed in the container;
a piston disposed for reciprocal movement in the piston chamber, the periphery of the piston sealingly engaging the chamber walls at two longitudinally spaced locations for dividing the piston chamber into a first fluid-tight volume between the two sealingly engaged positions and a second fluid tight volume between the second sealingly engaged position and the closed end of the piston chamber, the air inlet and air outlet ducts opening into the first volume and the fluid inlet and fluid outlet ducts opening into the second volume, the piston forcing air in the first volume of the piston chamber through the air outlet duct and the fluid in the second volume of the piston chamber through the fluid outlet duct when moving into the piston chamber and drawing air into the first volume of the piston chamber through the air inlet duct and fluid into the second volume of the piston chamber through the fluid inlet duct when moving out of the piston chamber;
an actuator movably mounted to the housing and operatively connected to the piston through an opening in the housing for reciprocating the piston upon movement of the actuator relative to the housing;
a follower movably disposed in the container, the periphery of the follower sealingly engaging the inner surface of the container so that the fluid is held between the follower and the open first end of the container; and
an air delivery tube connected at one end with the air outlet duct and opening at the other end into the container between the closed second end of the container and the follower for delivering air between the closed second end of the container and the follower upon movement of the piston into the piston chamber,
wherein reciprocating the piston in the piston chamber increases the air pressure in the closed second end of the container which forces the follower to move axially relative to the container toward the open first end of the container for pushing fluid toward the fluid inlet duct leading into the second volume of the piston chamber.

22. A fluid dispensing apparatus as recited in claim 21, wherein the fluid is selected from grease, caulk, glue or frosting.

23. A fluid dispensing apparatus as recited in claim 21, wherein the fluid is an automotive lubricant.
